(19) United States
(12) Patent Application Publication
(10) Pub. No.: US 2008/0248181 A1
(43) Pub. Date: Oct. 9, 2008

(54) Method For Conditioning Milk, and the Products Obtained and Obtainable Therewith

(75) Inventors: Cornelis Margaretha T.M. Bongers, Helmond (NL); Mathijs Hendrikus J. Martens, Tolkamer (NL); Luite Theodoor Netjes, Kampen (NL); Jan Sikkema, Zeegse (NL)

Correspondence Address: NORRIS, MCLAUGHLIN & MARCUS, P.A., 875 THIRD AVE, 18TH FLOOR, NEW YORK, NY, 10022, US

(73) Assignee: FRIESLAND BRANDS B.V, Meppel (NL)

(21) Appl. No.: 11/572,841

(22) PCT Filed: Jul. 29, 2005
(86) PCT No.: PCT/NL2005/000557

§ 371 Date: Dec. 6, 2007

(30) Foreign Application Priority Data
Jul. 30, 2004 (NL) 1026755

(51) Int. Cl. A23C 9/00

(52) U.S. Cl. 426/580; 426/442

(57) ABSTRACT

The invention relates to a method for conditioning milk and milk products, and in particular for controlling the gas composition in the milk at any time or during the complete treatment process. Further, the invention relates to the milk and milk products obtained and obtainable from this method, which milk and milk products possess improved properties. In particular, an improved light stability is obtained.

The invention relates to a method for conditioning milk, and in particular for setting, modifying or otherwise controlling the gas composition in the milk at any time or during the complete treatment process. Further, the invention relates to the milk and milk products obtained and obtainable from this method, which milk and milk products possess improved properties.

More in detail, the invention relates to the treatment of pasteurized milk and milk products which have an improved shelf life and/or an improved quality.

Producers and processors of milk are continuously faced with the stringent requirements imposed upon milk and milk products from a bacteriological point of view. At the same time, however, the product should remain reasonably priced. In practice, it is being attempted to take steps as early as possible in the production chain to prevent spoilage, at least quality deterioration, of the milk.

Nowadays, widely though not exclusively used methods of stalling the occurrence of decay and preventing quality deterioration comprise storage and transport at low temperature (lower than 7° C. and preferably lower than 4° C.); thermizing or otherwise heat-treating; activation of naturally occurring antibacterial enzymes in milk; controlled fermentation; and addition of preservatives.

Over the last years, moreover, much research has been done on the addition of CO₂ to freshly cooled milk.

Cooling raw milk inhibits the growth of mesophilic bacteria, which extends the storage stability of milk before it is to be processed. The growth of psychrotrophic (cold-loving) bacteria, however, is not inhibited and sometimes actually stimulated, while moreover the danger of post-contamination by psychrotrophic organisms remains present. Although these bacteria are killed off upon a thermal treatment of milk, this does not hold true of all enzymes secreted by these microorganisms, particularly not of proteases and lipases. These enzymes are capable of degrading different milk components and in particular proteins and fats, so that the keeping quality of heat-treated milk and the quality of dairy products prepared therefrom is adversely affected. Thus, the presence of lipases in milk gives an unpleasant rancid flavor. Microbial proteases contribute to bitterness, while moreover casein is degraded, which is unfavorable for, for instance, the cheese production from that milk.

It is known that CO₂ hinders the growth of psychrotrophic microorganisms causing milk decay. Thus, King and Mabbitt in J. Dairy Res. 49 (1982), 439-447 have investigated what the effects are of concentrations of 10-30 mM CO₂ on the growth of such organisms in untreated whole milk. On the basis of their work, they conclude that
“the inhibitory effects of CO₂ were not due to increased acidity or to displacement of dissolved O₂, but to the presence of CO₂ per se which induced an increase in the duration of the lag phase of growth and had only a small effect on the logarithmic phase”.

Hotchkiss et al. teach in J. Dairy Sci. 82 (1999) 690-695 that in pasteurized milk, the addition of CO₂ in amounts of 8.7 mM and higher in combination with the use of barrier films in packages, extends shelf life. In particular, for cooled milk, the shelf life has been found to increase by a day and a half when using 8.7 mM CO₂.

Further, the addition of CO₂ to milk is also taught by Ruas-Madiedo et al. in J. Agric. Food Chem. 46 (1998) 1552-1555 and in Eur. Food Res. Technol. 212 (2000) 44-47 (both to a pH of 6.1-6.3); Ma et al. in J. Dairy Sci. 84 (2001) 1959-1968 (200-1000 ppm), Roberts and Torrey in J. Dairy Sci. 71 (1988) 52-66 (20-30 mM), Ma and Barbano in J. Dairy Sci. 86 (2003) 1578-1589 (400-2400 ppm), Guillaume et al. in J. Dairy Sci. 85 (2002) 2098-2105 (to pH 5.8).

Also, Ma and Barbano in J. Dairy Sci. 86 (2003) 3822-3830 describe that carbonating raw skim milk by adding CO₂ in amounts of at least 600 ppm has an advantageous effect in pasteurization. In particular, this effect is attributed to the pH decrease which the CO₂ entails. CO₂ is described as a processing aid, which substance can be removed from the product again by applying vacuum. Previously, Loss and Hotchkiss (J. Food Prot. 65 (2002) 1924-1929) had already found a similar positive effect in milk with 44-58 mM CO₂.

In practice, there seems to be consensus about the fact that at CO₂ contents lower than 300-400 ppm no antimicrobiological effect is associated with the CO₂.

Despite the known bacteria-inhibiting action, carbon dioxide addition to milk is not used on a commercial scale yet.

Further, a great deal is already known about the oxygen content of a product and the effects thereof.

In an article by Murray et al. in J. Food Science 48 (1983), 1166-1169, passing nitrogen gas through raw milk is connected with an extended lag phase and slower growth rate of psychrotrophs and lactic acid bacteria.

Furthermore, for instance, D. B. Allen, in an article entitled “De-aeration of liquids” in “The Australian Grapegrower and Winemaker”, Annual Technical Issue (1993), pp. 152-153 (Ryan Publications, Adelaide Australia), describes that a low residual dissolved oxygen concentration in liquid foods provides advantages for the storage stability, the organoleptic properties and the nutritional value. As possible techniques for lowering the oxygen concentration, stripping with nitrogen gas or carbon dioxide gas is pointed out.

Deoxygenation or carbonation of liquid foods or biological products by injecting nitrogen gas or carbon dioxide gas into them is also described in U.S. Pat. No. 4,766,001.

In EP-A-0 442 781 it is described that the oxygen content in foods and drinks can be reduced utilizing ascorbate oxidase.

The old U.S. Pat. No. 2,428,044 describes the use of vacuum techniques for removing gases from liquid foods.

Further, a number of publications have appeared which discuss the effects of oxygen on UHT-heated milk, and in particular milk treated at a temperature of 130-150° C.

Andersson and Öste, in Milchwissenschaft 47 (1992) No. 7, 438-441, remark that upon such an UHT-heating, chemical changes occur that depend on the oxygen content in the milk. By using sufficient oxygen in the headspace of the package, it has been found that the free mercapto groups in the milk responsible for a cooked flavor are oxidized, so that this cooked flavor is expressed less.

Also Fink and Kessler come to the conclusion that the —SH groups produced in a UHT step are oxidized by oxygen in the milk.

The Japanese publication 2004-201601 concerns a high-temperature sterilized cream, in which the cooked flavor is reduced by the oxygen regime.

The French patent specification 782 803 describes the displacement of oxygen by compressed carbon dioxide from milk that is sterilized.

In the article by Lechner in Deutsche Milchwirtschaft (1976) 27, no. 14, Beil. Lebensmittel-Labor 4, pp. II-IV, changes of the oxygen content in sterilized milk are studied by determining the ascorbate content. Effects of degassing and airtight packaging proved to have the greatest influence on maintaining a virtually constant ascorbate content.

U.S. Pat. No. 3,065,086 describes the preparation of sterilized concentrated milk products. For these products too, the oxygen content plays a role in connection with off-flavors caused by sterilization.

The object of the present invention is, by managing the gas composition in milk or in the production of milk products, to come to one or more of the following advantages: an improved microbiological quality, an improved physical and/or chemical stability, including light stability and shelf life. Further, it is endeavored to limit the operational costs.

In particular, the invention focuses on microbiological quality and on preventing, at least reducing, the occurrence of a light flavor in heat-treated milk or a thus treated milk product, which heat treatment is milder than the UHT treatment. It is emphasized that light flavor is a completely different flaw in taste than the occurrence of a cooked flavor, which has been discussed above in connection with the UHT treatments and which is connected with sulfur groups which are present in the milk. Light flavor is a flavor which is formed in the presence of light in pasteurized products and in sterilized products. Trained sensory analysts associate light flavor with a mushroom and/or plastic taste. This flavor is not associated with sulfur groups; what it is associated with is as yet unknown.

It has now been found that by intervening in particular at the level of the oxygen content and, preferably, simultaneously managing the carbon dioxide economy, one or more of the just-mentioned advantages are obtained.

Thus, it has been found that pasteurized milk or a pasteurized milk product, which products usually have a shelf life of 7-8 days, attain a shelf life of about three weeks when the oxygen content in the packaged milk or the packaged milk product is lowered according to the invention to below 500 ppb and preferably to below the preferred values mentioned hereinafter.

It is possible to displace the oxygen from pasteurized milk or a pasteurized milk product by passing a non-oxygen containing gas into and/or through these liquid products, optionally combined with interim degassing using reduced pressure. For instance, good results are achieved by passing through nitrogen gas, carbon dioxide gas, laughing gas, inert gases, in particular argon, or mixtures thereof. In view of the costs, the use of inert gases is not preferred. When using, for instance, carbon dioxide gas, it needs to be taken into account that this gas has organoleptic effects, which are not always desirable; in such cases, the gas is to be applied in such a way that in the final product this gas falls or remains below the sensorily perceptible threshold.

When oxygen is to be displaced from the product, it may be necessary, at least desirable, to heat the product to values above the melting point (range) of the fat present in the milk or the milk product, in order that oxygen trapped in fat crystals be released from them. In a preferred embodiment, this can be suitably carried out by first decreaming milk in a conventional manner, and then heating the cream fraction and rendering it low in oxygen. For the skim milk fraction, a simpler method will then suffice.

In a preferred embodiment of the method according to the invention, steps are taken so that no oxygen, or hardly any, is taken up by the milk, starting from the oxygen content of milk in the mammal from which the milk is obtained. By nature, milk in the body of a mammal has an oxygen content that is very low; the oxygen content in milk is determined by the gas content in the blood. In blood, the oxygen content is low because it is bound to hemoglobin, whereas the carbon dioxide content is high. In cows, the total gas content in milk in the udder is at a value of about 4.5-6 vol. %, with 3.5-4.9 vol. % consisting of carbon dioxide, about 1 vol. % of nitrogen and less than 0.1 vol. % of oxygen.

During or after milking, the milk comes into contact with air, whereby an equilibrium is established, and so the milk will take up oxygen. As a rule, the oxygen content will stabilize at a value of 8-15 ppm. At the same time, a large part of the carbon dioxide diffuses from the milk. All this is enhanced when milking is done utilizing vacuum techniques.

By now ensuring that the milk does not come into contact with oxygen-containing gases during and/or after milking, the content of oxygen will substantially not rise.

Thus, for instance, milking can be done utilizing vacuum techniques, after which the milk is stored in a tank, with a non-oxygen atmosphere prevailing in the headspace of the tank, at least an atmosphere with an oxygen content so low that substantially no oxygen diffuses into the milk. Such an atmosphere can for instance be created by bubbling an excess of non-oxygen gas through the milk. Especially suitable for this purpose are food-grade gases, such as those described above for displacing oxygen.

Because in low-oxygen and non-sterile pasteurized products anaerobic growth of bacteria, in particular anaerobic growth of Clostridia, is a risk, the presence of carbon dioxide is desirable. Carbon dioxide inhibits this microbial growth and, associated with this, also the formation of lipases and proteases by these organisms. This contributes to an increased biochemical stability of the milk or the milk product.

Carbon dioxide, as stated, is by nature present in milk. In a preferred embodiment, accordingly, steps are taken to retain this carbon dioxide in the milk, or else steps are taken to maintain the carbon dioxide content at a value by introducing carbon dioxide into the milk or the milk product.

Thus, for instance in a cooling tank the milk can be saturated with carbon dioxide. At some 4° C., the saturation concentration is about 2900 ppm for carbon dioxide; however, a content of up to about 1500 ppm of carbon dioxide already provides advantages.

In a preferred embodiment of the method according to the invention, steps are taken so that prior to the pasteurization step the carbon dioxide content in the milk or the milk product is set at a value between 10 ppm and the saturation value of carbon dioxide in milk or that milk product. Preferably, the lower limit is 100 ppm, for instance at least 120 ppm or at least 150 ppm. The upper limit is preferably 1500 ppm.

In managing the oxygen content, it has been found according to the invention—as stated—that the photostability (light stability) of the milk or the milk product is improved. When a low-oxygen milk or low-oxygen milk product according to the invention is prepared, a light-stable product is obtained.

Furthermore, the invention relates to a packaged pasteurized milk or a packaged pasteurized milk product, the milk or the milk product having an oxygen content lower than 500 ppb, preferably lower than 250 ppb, more preferably lower than 150 ppb. Preferably, this packaged milk or this packaged milk product has a carbon dioxide content between 75 ppm, preferably 100 ppm, and the sensorily perceptible amount. The sensorily perceptible amount is the amount that is determined by a trained panel member; the value depends inter alia on the product temperature and for many people is at about some 300 ppm; for trained panel members some off-flavor already arises at a CO₂ content above 120-150 ppm.

As indicated above, at CO₂ contents lower than 300-400 ppm, no antimicrobiological effect is associated with the CO₂. It is thus surprising that a combination of the relatively low oxygen content with the relatively low carbon dioxide content not only prevents, or reduces, the light flavor, but moreover has an antimicrobiological effect, at least inhibits the growth of bacteria and other microorganisms.

Because low-oxygen pasteurized milk or a low-oxygen pasteurized milk product according to the invention possesses an improved light stability, no measures, at least fewer measures, need to be taken to treat the package in connection with transparency and the like. That is, no attention or less attention needs to be paid to light barriers.

In another aspect, the invention concerns a method for conditioning milk or a milk product, comprising at least a step in which the oxygen content in the milk or the milk product is set at a value lower than 500 ppb. In a preferred embodiment, the oxygen content is set such that the value is eventually lower than 250 ppb, more preferably lower than 150 ppb, and most preferably a value lower than 100 ppb.

Already upon an oxygen shock, that is, in a situation where the oxygen content is temporarily adjusted to a value lower than 500 ppb, preferably lower than 250 ppb, more preferably lower than 150 ppb and most preferably lower than 100 ppb, an improved microbiological quality is obtained and hence a longer shelf life.

In this description and the appended claims “milk product” (also “dairy product”) is intended to refer to products with milk constituents, while “milk constituents” includes milk, whey, permeate, milk protein (in particular casein, caseinate and/or whey protein, whether or not in concentrated form) and milk fat. Examples of such products are milk-based drinks, vla or drinks based on whey and permeate.

Further, in this description, the abbreviations “ppb” and “ppm” respectively mean “parts per billion parts” and “parts per million parts”. These ppb and ppm values can be determined in a manner known to those skilled in the art, for instance, for oxygen, in-line with an Orbisphere 3636 or off-line with an Orbisphere 3650; and for carbon dioxide, in-line with an Orbisphere 3610 or off-line with an Orbisphere 3654.

Pasteurization comprises conventionally a temperature treatment at a temperature to inactivate pathogenic bacteria. The minimum temperature dependents on the heating time. Usually the temperature is at least 73° C., although lower temperatures may be employed, e.g. at temperature of at least 72° C. (typically the minimal duration at 72° C. is 15 sec) or at a temperature of at least 63° C. (typically the minimal duration at 63° C. is 30 min ). At temperatures up to 85° C., light flavor formation occurs to a considerable extent. At temperatures above 85° C., this light flavor formation will also arise, though often to a somewhat lesser extent; however, the chance of cooked flavor formation then increases. The term “pasteurized milk or pasteurized milk product” denotes the milk or milk product which after being subjected to a conventional heating step (without the measures of the invention) has a light flavor discernible by a trained sensory analyst.

A heating step to a temperature of up to about 71° C. is referred to as thermizing. The invention can also be applied to thermized milk, in particular insofar as under thermizing conditions to be used, the occurrence of light flavor may arise in case the measures according to the invention are not taken.

Also ESL (extended shelf life) milk, not subjected to an UHT treatment, can therefore possess a light flavor, which is reduced or prevented by the measures according to the invention. ESL-milk is usually distinguishable from gepasteurised milk by testen the lactoperoxidase activity. This test is generally positive in pasteurised milk and negative in ESL-milk. ESL-milk is not sterile, but is sensitive to photo-oxidation.

As indicated above, an oxygen shock already proves sufficient to obtain microbial advantages. As a consequence, also, less stringent requirements can be imposed on the package regarding its gas barrier properties and especially its oxygen barrier properties, since some increase of the oxygen content in the package does not lead to an immediate decrease of the microbiological quality of the packaged product.

In a further aspect, the invention relates to the use of a gas mixture in milk or a milk product, such that the oxygen content is lower than 500 ppb, preferably lower than 250 ppb, more preferably lower than 150 ppb, for improving the light stability of the milk or the milk product.

In a further embodiment, the invention relates to the use of a gas mixture in milk or a milk product, such that the oxygen content is lower than 500 ppb, preferably lower than 250 ppb, more preferably lower than 150 ppb, and the carbon dioxide content is higher than 100 ppm, for extending the shelf life of the milk or the milk product. Preferably, the lower limit for carbon dioxide in this use is at least 120 ppm, preferably at least 200 ppm. The upper limit of the carbon dioxide content for this use is in fact determined by the saturation concentration.

In managing the oxygen content and possibly also the carbon dioxide content in conformity with the present invention, a number of negative organoleptic, quality and nutritional value effects, such as oxidative rancidity formation, photocatalyzed adverse flavor and/or odor formation, oxygen-induced sulfur reactions, color fading and volatile compound oxidation, do not occur or in any case do so to a reduced extent. In addition, it has been found that micronutrients such as vitamins, and in particular the B vitamins and C vitamins, remain intact to an increased extent, which also enhances the quality of the milk or the milk product.

The best results are obtained by setting the oxygen content, and preferably also the carbon dioxide content, of the milk, while the oxygen and the carbon dioxide are also removed from the fat fraction. This removal from the fat fraction is preferably carried out at a temperature at which the fat is present in the milk in molten condition. Very good results are then achieved by removing oxygen by means of flash vacuum techniques.

What is specifically not described in the prior art, as far as the inventors know, is that also the gases, in particular oxygen and carbon dioxide, present in fat are to be removed.

The degassed milk is subsequently pasteurized under anoxic conditions.

During these steps, in a preferred embodiment, light contact with the milk is avoided.

Where the steps of keeping the oxygen content low and keeping the carbon dioxide content high according to the invention are already carried out at the site where milking is done, a milk raw material is obtained which is not only of higher quality in composition and microbially, but also has a longer shelf life whilst preserving the positive properties. This means that an economic advantage can be achieved in that the milk needs to be collected or transported to the milk reception stores of milk processing plants less often.

When steps as mentioned in the preceding paragraph are not taken until during transport or in the milk reception stores, likewise advantages and in particular advantages in microbiological quality are obtained. These advantages can be in the order of the advantages to be obtained with a thermization step, which conventionally comprises heating up to a temperature of 50-60° C., or even with a conventional pasteurization step.

For that matter, advantages are also obtained when lowering the oxygen content and setting a particular carbon dioxide content according to the invention do not take place until after the treatments of the milk and the processing into milk products. In that case, in particular the advantages of extending shelf life and the improved product quality are obtained. Instead of an improved shelf life, it is also possible to obtain the conventional shelf life whilst packaging in cheaper, at least qualitatively lower-grade, packaging material.

When it has been chosen to saturate the milk upon the milking step, at least to load it with carbon dioxide to a high extent, then at the reception, preferably, prior to the separation of the whole milk into a cream and a skim milk fraction, a degassing step is used, conventionally after a heating step to above the melting temperature of milk fat. This is because carbon dioxide dissolves well in milk fat and hence may possibly entail problems, at least inconveniences, during later processing of the cream fraction. Incidentally, the cream fraction too, after being obtained, can be heated and subsequently be degassed.

Presently, the invention will be further elucidated in and by the following non-limiting examples. In these examples, reference is made to drawing figures, wherein:

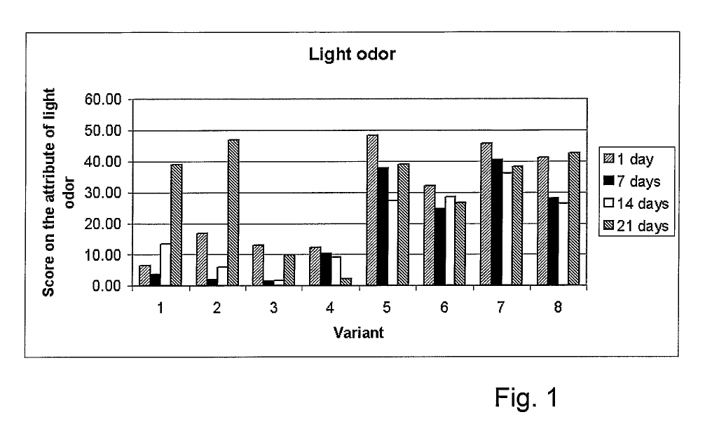

FIG. 1 shows the effect of gassing and/or anoxic filling on the light odor;

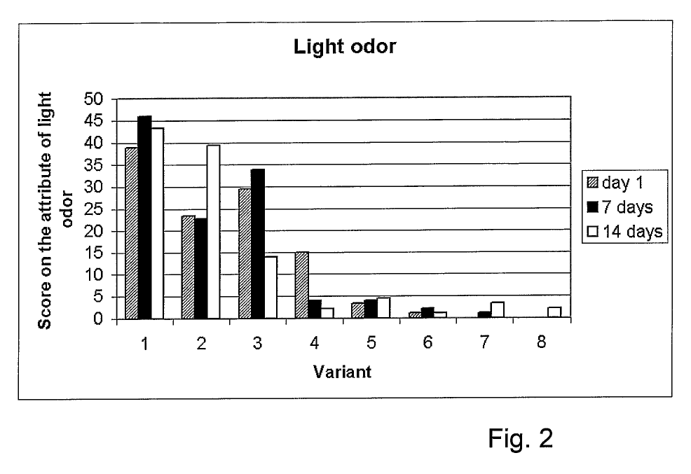

FIG. 2 shows the effect of degassing and/or anoxic filling on the light odor; and

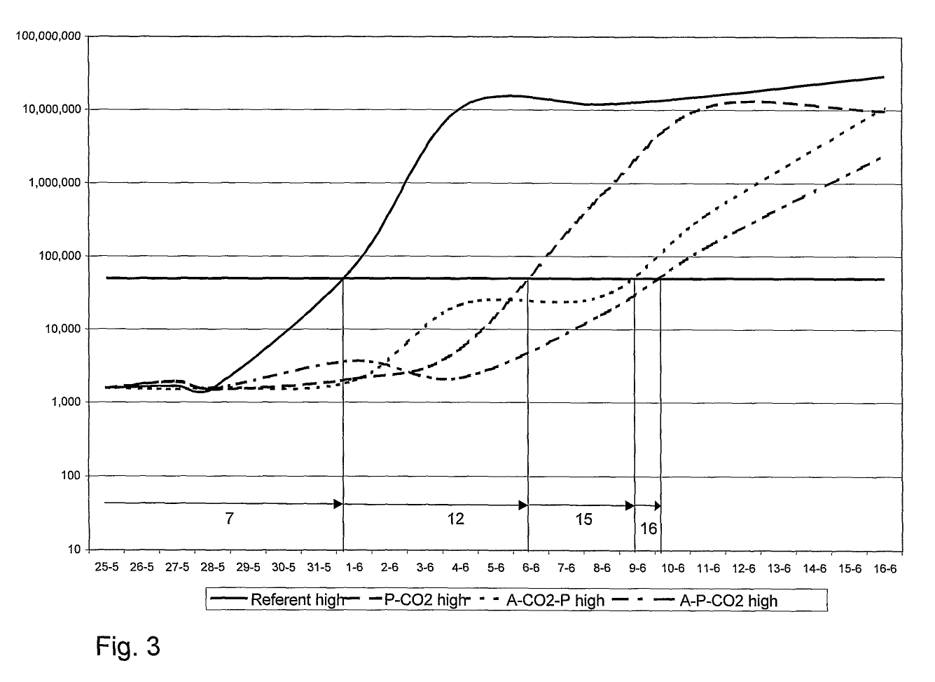

FIG. 3 shows the results of standard bacterial plate counts of May 25 to Jun. 16, 2004.

### EXAMPLE 1

Low-fat milk was subjected at a temperature of 70° C. to bubbling with nitrogen gas to degas such that oxygen values below 500 ppb were measured with an Orbisphere gas meter. The degassed low-fat milk was filled under anoxic conditions into non-translucent bottles, as well as filled without imposing particular restrictions on oxygen contact, so that the product then came into contact with oxygen only during filling and through exchange with the gas in the headspace of the bottles.

For comparison, also low-fat milk not stripped of oxygen was filled, anoxically or not so.

In the following table, the variants are shown.

Variant

| | 1 | 2 | 3 | 4 |
|---|---|---|---|---|
| Degassing | yes | yes | no | no |
| Anoxic filling | yes | no | yes | no |
| Exposure to light | no | no | no | no |

### EXAMPLE 2

Example 1 was repeated, and the products were rated for light stability by a sensory panel. In particular, the variants 5-8, corresponding to the respective variants 1-4 from Example 1 (see next table) were, prior to rating, exposed to 50,000 Lux for 40 minutes at 7° C.

Variant

| | 5 | 6 | 7 | 8 |
|---|---|---|---|---|
| Degassing | yes | yes | no | no |
| Anoxic filling | yes | no | yes | no |
| Exposure to light | yes | yes | yes | yes |

By the panel, light odor was described as plastic/chemical/synthetic, combined with spoilt, cheesy, and cowshed air, and expressed in values between 0 and 100, with 0 meaning free of light odor.

Upon exposure with a light intensity of 50,000 Lux it was established that oxygen disappeared from the product (1-1.5 ppm).

The results are represented in FIG. 1 showing the effect of gassing and/or anoxic filling on the light odor (scale 0-100).

### EXAMPLE 3

Examples 1 and 2 were repeated but the low-fat milk was now degassed under vacuum at a temperature of 55° C. instead of at 7° C. In the following table the variants are described.

| Variant | 1 | 2 | 3 | 4 | 5 | 6 | 7 | 8 |
|---|---|---|---|---|---|---|---|---|
| Degassing | no | no | yes | yes | yes | no | no | yes |
| Anoxic filling | no | yes | no | yes | yes | yes | no | no |
| Exposure to light | yes | yes | yes | yes | no | no | no | no |

FIG. 2 shows the effect of degassing and/or anoxic filling on the light odor (scale 0-100).

It appears that when the oxygen content is higher in the bottles, more light flavor arises after exposure. The effect of oxygen, probably trapped in the fat fraction during filling, now egressing from the fat, is clearly apparent.

Based on the results of the examples, it is assumed that the manner of degassing of Example 3 also removes oxygen from the fatty phase, whereas bubbling with nitrogen (Examples 1 and 2) does not liberate, let alone displace, oxygen trapped in the fatty phase.

### EXAMPLE 4

Low-fat milk was treated on May 25, 2004, as follows:
(1) pasteurized and, further untreated, filled;
(2) pasteurized and then injected with CO₂ to a CO₂ value of 200 ppm and filled;
(3) subjected to bubbling with nitrogen to an oxygen value below 500 ppb, injected with CO₂ to a CO₂ value of 200 ppm, pasteurized and filled; and
(4) pasteurized, subjected to bubbling with sterile nitrogen to an oxygen value below 500 ppb, injected with CO₂ to a CO₂ value of 200 ppm and filled.

From the bottles, samples were taken daily, which were subjected to a standard plate count.

The results of the plate counts are represented in FIG. 3. In this FIG. 3, the horizontal line reflects the critical value of the number of bacteria above which the product is not storable anymore.

1. Packaged pasteurized milk or packaged pasteurized milk product, wherein the milk or the milk product has an oxygen content lower than 500 ppb, preferably lower than 250 ppb, more preferably lower than 150 ppb.

2. Packaged milk or packaged milk product according to claim 1, having a carbon dioxide content between 100 ppm and the sensorily perceptible amount.

3. A method for conditioning pasteurized milk or a pasteurized milk product, comprising at least a step in which the oxygen content in the milk or the milk product is set at a value lower than 500 ppb.

4. A method according to claim 3, wherein the oxygen content is set at a value lower than 250 ppb and preferably lower than 150 ppb.

5. A method according to claim 3, wherein the oxygen content in the milk or the milk product is set during a heating step to above the melting range of the milk fat.

6. A method according to claim 3, wherein the oxygen content is set by displacing oxygen using a non-oxygen gas.

7. A method according to claim 3, wherein steps are taken so that no oxygen or hardly any oxygen is taken up by the milk.

8. A method according to claim 3, wherein steps are taken so that the carbon dioxide content in the milk or the milk product is set at a value between 100 ppm and the saturation values of carbon dioxide, preferably between 120 ppm and 1500 ppm, and more preferably between 150 ppm and 500 ppm.

9. (canceled)

10. (canceled)
